(19) United States
(12) Patent Application Publication
(10) Pub. No.: US 2003/0224177 A1
(43) Pub. Date: Dec. 4, 2003

(54) Epoxy resin composition

(75) Inventors: Katsuhiro Furuta, Tsukuba-shi (JP); Toshiaki Hayashi, Tsukuba-shi (JP)

Correspondence Address: SUGHRUE MION, PLLC, 2100 PENNSYLVANIA AVENUE, N.W., WASHINGTON, DC, 20037, US

(73) Assignee: SUMITOMO CHEMICAL COMPANY, LIMITED

(21) Appl. No.: 10/445,946

(22) Filed: May 28, 2003

(30) Foreign Application Priority Data
May 30, 2002 (JP) 2002-157020
Nov. 27, 2002 (JP) 2002-343470

(51) Int. Cl. B32B 27/38

(52) U.S. Cl. 428/413

(57) ABSTRACT

An epoxy resin composition comprising a phosphorus-containing epoxy resin and an aromatic polysulfone resin. The epoxy resin composition gives an cured product has not only excellent toughness but also high flame retardancy and high heat resistance, and is advantageous as an insulation material for a multi-layer printed wiring board, particularly, as an insulation material for a build up substrate.

### BACKGROUND OF THE INVENTION

1. Field of the Invention

The present invention relates to an epoxy resin composition, more particularly, to an epoxy resin composition comprising a phosphorus-containing epoxy resin and an aromatic polysulfone resin. 2. Description of the Related Art

Recently, with the progress of electronics field, downsizing and speeding-up of electronics device have been developed, and consequently, high density by fine patterning and high reliability are required also in multi-layer printed wiring boards. Particularly, for attaining the high density, build-up substrates are often used as multi-layer printed wiring boards. In this case, insulation layers mainly made of an epoxy resin are piled, therefore, cracks occur in the insulation layers due to stress from outside, thermal shock and the like, to decrease reliability problematically. Therefore, it has been required to improve the toughness of insulation material.

As a method of improving the toughness of an insulation material for build-up substrate, there are proposed methods of combining an epoxy resin and a super engineering plastic such as aromatic polysulfone (for example, Japanese Patent Application Laid-Open (JP-A) Nos. 7-33991, 7-34048).

For multi-layer printed wiring boards, flame retardancy is also required, and there are also proposed flame retarding methods in using a combination of an epoxy resin and a super engineering plastic, wherein a reaction product of an epoxy resin with a phosphorus compound having a P-H bond such as 9,10-dihydro-9-oxa-10-phosphaphenenthrene-10-oxide is used as the epoxy resin (for example, JP-A Nos. 2000-216549, 2000-239525).

### SUMMARY OF THE INVENTION

As the result of intensive studies about the reaction product of an epoxy resin with a phosphorus compound, the present inventors have found that by combining a super engineering plastic and a reaction product of an epoxy resin with a specific phosphorus compound having no P-H bond, a cured product having not only excellent toughness but also high flame retardancy and high heat resistance can be obtained, leading to completion of the invention.

Namely, the present invention provides a practically excellent epoxy resin composition comprising: (A) a phosphorus-containing epoxy resin obtained by reacting at least one phosphorus compound selected from 10-(2,5-dihydroxyphenyl)-10H-9-oxa-10-phosphaphenanthrene-10-oxide and 10-hydroxy-10H-9-oxa-10-phosphaphenanthrene-10-oxide, with an epoxy resin; and (B) an aromatic polysulfone.

### DETAILED DESCRIPTION OF THE INVENTION

The phosphorus-containing epoxy resin is obtained by reacting a specific phosphorus compound with an epoxy resin.

As the epoxy resin, exemplified are: di-functional epoxy reins derived from di-valent phenols such as bisphenol A, bisphenol F, bisphenol S, dihydroxybiphenyl, dihydroxynaphthalene, dihydroxystilbene, alkyl-substituted hydroquinone and the like; novolak type epoxy resins such as phenol novolak, cresol novolak, bisphenol A novolak and the like; poly-functional epoxy resins derived from polycondensates of phenols such as phenol, alkyl-substituted phenol, and naphthol with aldehydes such as benzaldehyde, hydroxybenzaldehyde, alkyl-substituted and terephthalaldehyde; epoxy resins derived from poly-adducts of phenols and cyclopentadiene; and the like. These can also be used in combination of two or more thereof, according to requirements.

Among the above epoxy resins, poly-functional epoxy resins are preferable from the standpoints of the heat resistance of the resulted cured product and reactivity with a phosphorus compound, and particularly, poly-functional epoxy resins represented by formula (1) or (2) are preferable.

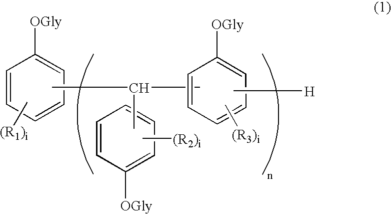

(wherein, n represents an average repeating number of 1 to 10; R₁, R₂ and R₃ each independently represent an alkyl group having 1 to 10 carbon atoms, a cycloalkyl group having 5 to 7 carbon atoms, or a hydrocarbon group having 6 to 20 carbon atoms which contains a cycloalkyl group having 5 to 7 carbon atoms; i each independently represent an integer of 0 to 4, and when i is 2 or more, a plurality of R₁, R₂ and R₃ may be mutually the same or different; and Gly represents a glycidyl group.)

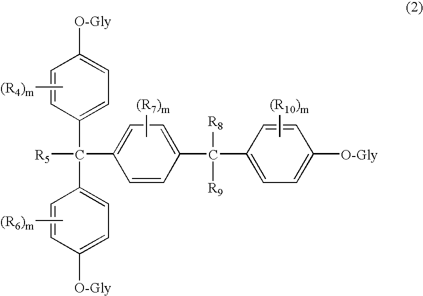

(wherein, R₄, R₆, R₇ and R₁₀ each independently represent an alkyl group having 1 to 10 carbon atoms, a cycloalkyl group having 5 to 7 carbon atoms, or a hydrocarbon group having 6 to 20 carbon atoms which contains a cycloalkyl group having 5 to 7 carbon atoms; m each independently represent an integer of 0 to 4, and when m is 2 or more, a plurality of R₄, R₆, R₇ and R₁₀ may be mutually the same or different; R₅, R₈ and R₉ each independently represent a hydrogen atom or an alkyl group having 1 to 3 carbon atoms, and Gly represents a glycidyl group.).

As for R₁, R₂ and R₃ in formula (1), Examples of the alkyl group having 1 to 10 carbon atoms include methyl, ethyl, n-propyl, i-propyl, n-butyl, t-butyl, pentyl, hexyl, heptyl and the like.

Examples of the cycloalkyl group having 5 to 7 carbon atoms include cyclopentyl, cyclohexyl, cycloheptyl and the like, and examples of the hydrocarbon group having 6 to 20 carbon atoms which contains a cycloalkyl group having 5 to 7 carbon atoms include cyclopentylmethyl, cyclohexylmethyl, cyclohexylethyl and the like.

Of them, R₁, R₂ and R₃ are preferably selected from methyl, ethyl and t-butyl.

n represents an average repeating number of 1 to 10. n is preferably 1 to 5, and more preferably 1 to 3. i is preferably 0 to 3, and it more preferably 0 to 2.

As for R₄, R₆, R₇ and R₁₀ in formula (2), examples of the alkyl group having 1 to 10 carbon atoms include methyl, ethyl, n-propyl, i-propyl, n-butyl, t-butyl, pentyl, hexyl, heptyl and the like.

Examples of the cycloalkyl group having 5 to 7 carbon atoms include cyclopentyl, cyclohexyl, cycloheptyl and the like, and examples of the hydrocarbon group having 6 to 20 carbon atoms which contains a cycloalkyl group having 5 to 7 carbon atoms include cyclopentylmethyl, cyclohexylmethyl, cyclohexylethyl and the like.

Of them, R₄, R₆, R₇ and R₁₀ are preferably selected from methyl and ethyl. m represents an integer of preferably 0 to 3, and more preferably 0 to 2.

As for R₅, R₈ and R₉, examples of the alkyl group having 1 to 3 carbon atoms include methyl, ethyl and the like. Of them, R₅, R₈ and R₉ are preferably selected from a hydrogen atom and methyl.

The above reaction of an epoxy resin and a phosphorus compound is carried out by a known method, for example, according to JP-A No. 2000-309623. Specifically, exemplified is a method in which an epoxy resin and a phosphorus compound are stirred under positive pressure or normal pressure, while heating at 100 to 200° C. for 1 to 24 hours, in bulk condition or in the presence of an inert solvent such as methyl ethyl ketone, benzene, cyclohexane and the like. Here, it is preferable that the phosphorus compound is used so that it is not excess based on a glycidyl group of the epoxy resin. When a solvent is used, it is also possible to obtain the desired material by, for example, distilling off the solvent. Further, a metal oxide, an inorganic base, an organic base or the like can also be used as a catalyst.

The epoxy resin composition of the present invention is characterized in that a phosphorus-containing epoxy resin as the component (A) is combined with an aromatic polysulfone resin as the component (B).

Here, as the aromatic polysulfone resin, for example, known resins such as polysulfone, polyether sulfone and the like are exemplified. Of them, polyether sulfone is preferable since a cured product can be toughened effectively.

As the aromatic polysulfone resin, there are known those having, as the terminal group, a halogen atom, alkoxy group, phenolic hydroxyl group and the like, and from the standpoint of the heat resistance of a cured product, those having a halogen atom as the terminal group are preferable. From the standpoints of the solvent resistance and toughness of a cured product, a phenolic hydroxyl group is preferable, and in this case, those having phenolic hydroxyl groups as each of the both terminal groups are more preferable. The aromatic polysulfone resin preferably has a molecular weight of 1000 to 100000. When it is less than 1000, there is a tendency that sufficient toughness of the resin is not obtained, leading to fragility. When it is over 100000, solubility of the resin in a solvent is poor and handling thereof becomes difficult.

Such a polysulfone resin may be a product by a known method, or a commercially available product, for example: SUMIKA EXCEL, trade name manufactured by Sumitomo Chemical Co., Ltd.; REDEL, UDEL P-1700, trade name manufactured by Amoco; and ULTRASON E, trade name manufactured by BASF.

A phosphorus-containing epoxy resin as the component (A) is used in an amount of usually from 10 to 90% by weight, preferably from 20 to 80% by weight based on the total resin weight (total weight of a phosphorus-containing epoxy resin as the component (A) and an aromatic polysulfone resin as the component (B), and a curing agent. When the amount is too small, the flame retardant effect tends to decrease, and when too large, the toughness of a cured product tends to lower.

An aromatic polysulfone resin as the component (B) is used in an amount of usually from 5 to 50% by weight based on the total resin amount. When the amount is too small, toughness tends to lower, and when too large, the processability of a composition lowers and water absorption of a cured product tends to increase.

The epoxy resin composition of the present invention comprises, as an essential component, a phosphorus-containing epoxy resin as the component (A) and an aromatic polysulfone resin as the component (B), as described above, and in addition to them, can comprise an epoxy resin curing agent.

As such a curing agent, known curing agents can be adopted. Exemplified are: poly-valent phenol-type epoxy resin curing agents such as phenol novolak, tris(hydroxyphenyl) alkanes, phenol-modified polybutadiene, phenols aralkyl resins, poly-adducts of phenols and dicyclopentadiene, and the like; amine-type epoxy resin curing agents such as dicyandiamide, diaminodiphenylmethane, diaminodiphenylsulfone and the like; and acid anhydride-type epoxy resin curing agents such as pyromellitic anhydride, trimellitic anhydride, benzophenone tetracarboxylic dianhydride and the like. These can also be used in combination of two or more, if necessary.

Of them, poly-valent phenol-type curing agents are preferable from the standpoint of low water absorption of a cured product. Further, aminotriazine novolak resins containing phenol as a raw material and modified with a compound having a triazine structure such as melamine, benzoguanamine and the like are also preferably used since a nitrogen atom contained in the compound contributes to flame retardancy.

The epoxy resin curing agent is usually selected so that the glass transition temperature of the resulting cured product reaches the highest level. For example, when a phenol novolak resin is used as a curing agent, it may be advantageous that the ratio of the epoxy equivalent of a phosphorus-containing epoxy resin to the hydroxyl group equivalent of a curing agent is 1:1. When an aminotriazine novolak resin is used as a curing agent, an amino group also contributes to curing, therefore, it may be advantageous to control appropriately the using ratio.

The epoxy resin composition of the present invention can also contain a curing catalyst for the purpose of promoting a curing reaction. Examples of such a curing catalyst include: organic phosphine compounds such as triphenylphosphine, tri-4-methylphosphine, tri-4-methoxyphenylphosphine, tributylphosphine, trioctylphosphine, tri-2-cyanoethylphosphine and the like and tetraphenyl borate salts thereof; tertiary amines such as tributylamine, triethylamine,

1,8-diazabicyclo(5,4,0)undecene-7, triamylamine and the like; quaternary ammonium salts such as benzyltrimethyl ammonium chloride, benzyltrimethyl ammonium hydroxide, triethyl ammonium tetraphenylborate and the like; 2-ethylimidazole, 2-ethyl-4-methylimidazole and the like. Two or more of them can also be used according to requirements. Of them, organic phosphine compounds and imidazoles are preferably used.

A curing catalyst can be added at any compounding ratio so that the desired gel time is obtained. Usually, it is preferable that the curing catalyst is compounded so that the gel time of a resin composition is 1 to 15 minutes at a given temperature of 80 to 250° C.

The epoxy resin composition of the present invention can further contain an inorganic filler and the like, according to requirements.

As such an inorganic filler, for example, silica, titanium oxide, alumina and the like are exemplified, and two or more of them can also be used. Particularly, silica is preferably used since it has low dielectric constant and low dielectric loss tangent.

When an inorganic filler is used, it is used usually in an amount of 5 to 40% by weight based on the total resin amount. The average particle diameter of the filler is preferably from 0.1 to 3 μm. When the average particle diameter is too small, there is a tendency that fillers easily coagulate and workability deteriorates, and when too large, there is a tendency that roughened surface becomes coarse during a surface roughening process in copper plating conducted for producing a multi-layer printed wiring board, and it is not suitable for finer patterning.

The epoxy resin composition of the present invention can be used also as a varnish.

The varnish can be produced by mixing components with a solvent composed of at least one solvent capable of dissolving an aromatic polysulfone resin such as dimethylformamide, N-methyl-2-pyrrolidone, 4-butyrolactone, methyl ethyl ketone, methyl isobutyl ketone, N,N-dimethylacetamide, dimethyl sulfoxide, cyclohexanone, methylcellosolve, ethylcellosolve, n-hexane, methanol, ethanol, acetone and the like.

The epoxy resin composition of the present invention can be used also as a dry film. The dry film can be produced, for example, by applying the above varnish containing a curing agent on a substrate in the form sheet made of PET and the like using a roll coater, table coater and the like to form a thin film, distilling off the solvent for semi-curing. The conditions of semi-curing are appropriately selected depending on the kinds and use amounts of the components and solvent, and usually semi-curing are conducted at 50 to 200° C. for 1 to 90 minutes.

The above-mentioned dry film can also be made into a film of a three-layer structure constituted of substrate/dry film/protective film by providing a film made of polyethylene and the like as the protective film. In use, the protective film is peeled, and the film can be used as a transfer sheet on a substrate.

Further, when the epoxy resin composition of the present invention is used for a resin laminated copper foil, the epoxy resin composition of the present invention and a curing agent are dissolved in an organic solvent to prepare a varnish which is applied on an anchor surface of the copper foil using a roll coater, table coater and the like to form a thin film, and the solvent is distilled off for semi-curing, to give a resin laminated copper foil. The conditions of semi-curing are appropriately selected depending on the kinds and use amounts of the components and solvent, and usually semi-curing are conducted at 50 to 200° C. for 1 to 90 minutes.

For producing a multi-layer printed wiring board using the epoxy resin composition of the present invention, in the case of use of a varnish containing a curing agent, the varnish is directly applied on a core substrate using a roller coater, table coater and the like, the solvent is distilled off, then, the varnish is heated for curing to form an insulation layer. In the case of use of a dry film, an insulation layer is formed on a core substrate using a vacuum laminator and heated for curing. The lamination is conducted usually at 60 to 150° C. under a pressure of 1 kg/cm² to 10 kg/cm². In the case of a resin laminated copper foil, an insulation layer is formed on a cores substrate by press-molding. The press conditions include usually a molding pressure of 10 kg/cm² to 100 kg/cm², a temperature of 80 to 250° C. and a time of 20 to 300 minutes. Then, vias formation and circuit formation are conducted, and these are repeated to produce a multi-layer printed wiring board.

### EXAMPLE

Examples of the present invention will be shown below, but they do not limit the scope of the invention.

### Synthesis Example 1

416 g of a poly-functional epoxy resin (TECHMORE VG 3101, manufactured by Mitsui Chemicals, Inc., epoxy equivalent: 210), 110 g of 10-(2,5-dihydroxyphenyl)-10H-9-oxa-10-phosphaphenanthrene-10-oxide (HCA-HQ, manufactured by Sanko Co., Ltd.) and 0.5 g of tetramethyl ammonium chloride as a reaction catalyst were used in the form of aqueous solution, and they were reacted at 120 to 180° C. for 8 hours to obtain a phosphorus-containing epoxy resin. This had an epoxy equivalent of 410 and a phosphorus-content of 2% by weight. This is abbreviated as P1.

### Synthesis Example 2

350 g of a bis A type epoxy resin (YD-128M, manufactured by Toto Kasei K.K.), 93 g of 10-(2,5-dihydroxyphenyl)-10H-9-oxa-10-phosphaphenanthrene-10-oxide (HCA-HQ, manufactured by Sanko Co., Ltd.), 2.2 g of triphenylphosphine as a reaction catalyst and 450 g of cyclohexanone as a solvent were used, and reacted under nitrogen at 160° C. for 6 hours, then, the solvent was distilled off, to obtain a phosphorus-containing epoxy resin. This had a phosphorus content of 2% by weight. This is abbreviated as P2.

### Synthesis Example 3

700 g of a bis A type epoxy resin (manufactured by Toto Kasei K. K.) and 114 g of 9,10-dihydro-9-oxa-10-phosphaphenanthrene-10-oxide (HCA, manufactured by Sanko Co., Ltd.) were reacted under nitrogen at 160 C for 6 hours, to obtain a phosphorus-containing epoxy resin. This had a phosphorus content of 2% by weight. This is abbreviated as P3.

### Example 1

### Comparative Examples 1, 2

A resin composition having a formulation ratio described in Table 1 was heated and dissolved in N,N,-dimethylacetamide to produce a resin varnish. This resin varnish was applied on PET to give a thickness after curing of 80 μm, then, dried in a hot air dryer of 80° C. for 1 hour, and the resulted film was peeled from PET. This film was subsequently cured at 180° C. for 2 hours to obtain a test film. This test film was stamped out by ASTM No. 4 dumbbell, and a tensile test was conducted. For a flame retardant test, the varnish was applied on both surfaces of a non-halogen flame retardant substrate having a thickness of 0.4 mm (manufactured by Toshiba Chemical K.K.) so that the resin thickness after curing was 100 μm and dried, and subsequently, cured at 180° C. for 2 hours to produced a sample for a flame retardant test. The test was conducted according to JIS-C-6481. The results are shown in Table 1.

TABLE 1

| | | Comparative | Comparative |
|---|---|---|---|
| | Example 1 | Example 1 | Example 2 |
| P1 | 60.1 | — | 85.8 |
| Poly-functional | — | 52.9 | — |
| epoxy resin | | | |
| KA-7052-L2 | 9.9 | 17.1 | 14.2 |
| PES5003P | 30 | 30 | — |
| 2E4MZ | 0.1 | 0.1 | 0.1 |
| Flame retardancy | Corresponding | Combustion | Corresponding |
| | to V-0 | | to V-0 |
| Tensile | | 9 | |
| elongation (%) | 10 | | 2 |

Poly-functional epoxy resin: manufactured by Mitsui Chemicals, Inc., trade name: TECHMORE VG 3101

KA-7052-L2: manufactured by Dainippon Ink and Chemicals, Inc., melamine-modified phenol novolak

PES5003P: manufactured by Sumitomo Chemical Co., Ltd., terminal phenol-modified polyether sulfone 2E4MZ: manufactured by Shikoku Chemicals Corp., imidazole

### Examples 2, 3

### Comparative Examples 4, 5

A resin composition having a formulation described in Table 2 was heated and dissolved in cyclohexanone, to prepare a resin varnish. This varnish was applied on a glass plate, then, a solvent was distilled off at 160° C. for 20 minutes. This semi-cured material was scraped from the glass plate, and molded by a flow tester at 180° C. for 5 minutes. This molded article was cured in a hot air drier at 180° C. for 2 hours, and TMA of this cured article was measured. The results are shown in Table 2.

TABLE 2

| | | | Comparative | Comparative |
|---|---|---|---|---|
| | Example 2 | Example 3 | Example 3 | Example 3 |
| P2 | 70.00 | 56.92 | — | — |
| P3 | — | — | 70.00 | 53.38 |
| KA-7052-L2 | — | 13.08 | — | 16.62 |
| PES5003P | 30.00 | 30.00 | 30.00 | 30.00 |
| 2E4MZ | 2.10 | 0.28 | 3.50 | 0.42 |
| Tg(° C.) | 149 | 124 | 129 | 106 |

The epoxy resin composition of the present invention gives an insulating cured product not only excellent in toughness but also having high flame retardancy and high heat resistance by using an epoxy resin reacted with a specific phosphorus compound having not P—H bond combined with a super engineering plastic. Therefore, the epoxy resin composition of the present invention is advantageous as an insulation material for a multi-layer printed wiring board, particularly, as an insulation material for a build up substrate.

What is claimed is:

1. An epoxy resin composition comprising:
(A) a phosphorus-containing epoxy resin obtained by reacting at least one phosphorus compound selected from 10-(2,5-dihydroxyphenyl)-10H-9-oxa-10-phosphaphenanthrene-10-oxide and 10-hydroxy-10H-9-oxa-10-phosphaphenanthrene-10-oxide, with an epoxy resin; and
(B) an aromatic polysulfone.

2. The epoxy resin composition according to claim 1 wherein the epoxy resin is a poly-functional epoxy resin.

3. The epoxy resin composition according to claim 2 wherein the poly-functional epoxy resin is an epoxy resin represented by formula (1) or (2): 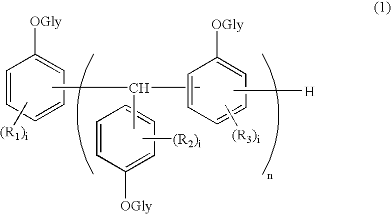
(wherein, n represents an average repeating number of 1 to 10; R₁, R₂ and R₃ each independently represent an alkyl group having 1 to 10 carbon atoms, a cycloalkyl group having 5 to 7 carbon atoms, or a hydrocarbon group having 6 to 20 carbon atoms which contains a cycloalkyl group having 5 to 7 carbon atoms; i each independently represent an integer of 0 to 4, and when i is 2 or more, a plurality of R₁, R₂ and R₃ may be mutually the same or different; and Gly represents a glycidyl group.) 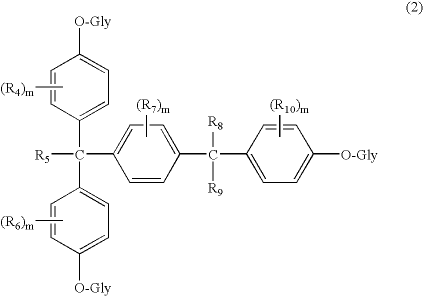
(wherein, R₄, R₆, R₇ and R₁₀ each independently represent an alkyl group having 1 to 10 carbon atoms, a cycloalkyl group having 5 to 7 carbon atoms, or a hydrocarbon group having 6 to 20 carbon atoms which contains a cycloalkyl group having 5 to 7 carbon atoms; m each independently represent an integer of 0 to 4, and when m is 2 or more, a plurality of R₄, R₆, R₇ and R₁₀ may be mutually the same or different; R₅, R₈ and R₉ each independently represent a hydrogen atom or an alkyl group having 1 to 3 carbon atoms, and Gly represents a glycidyl group.).

4. The epoxy resin composition according to any one of claims 1 to 3 wherein the polysulfone resin is a polyether sulfone.

5. The epoxy resin composition according to claim 4 wherein the polyether sulfone has a phenolic hydroxyl group as terminal group.

6. An epoxy resin varnish comprising the epoxy resin composition according to any one of claims 1 to 3 and an organic solvent.

7. A dry film obtained by using the epoxy resin composition according to any one of claims 1 to 3.

8. A resin laminated copper foil obtained by using the epoxy resin composition according to any one of claims 1 to 3.

9. A multi-layer printed wiring board obtained by using, as an insulation layer, a cured product obtained from the epoxy resin composition according to any one of claims 1 to 3.

10. A phosphorus-containing epoxy resin obtained by reacting at least one phosphorus compound selected from 10-(2,5-dihydroxyphenyl)-10H-9-oxa-10-phosphaphenanthrene-10-oxide and 10-hydroxy-10H-9-oxa-10-phosphaphenanthrene-10-oxide, with an epoxy resin.
